(19) United States
(12) Patent Application Publication
(10) Pub. No.: US 2023/0138198 A1
(43) Pub. Date: May 4, 2023

(54) FLUID RECIRCULATION

(71) Applicant: Hewlett-Packard Development Company, L.P., Spring, TX (US)

(72) Inventor: David BUTINYA TEIXIDO, Palo Alto, CA (US)

(73) Assignee: Hewlett-Packard Development Company, L.P., Spring, TX (US)

(21) Appl. No.: 17/995,719

(22) PCT Filed: Apr. 9, 2020
(86) PCT No.: PCT/US2020/027514

§ 371 Date: Oct. 7, 2022

(51) Int. Cl. B41J 2/18

(52) U.S. Cl. CPC B41J 2/18

(57) ABSTRACT

According to an example, a recirculation device having a fluid interconnect assembly comprises an open state and a closed state. The fluid interconnect assembly may comprise an elastic element, a first hollow element, a second hollow element, and a seal movable along the fluid interconnect assembly. The first hollow element and the second hollow element comprise an opening, wherein the hollows element are fluidly connected. In the open state of the device, the first hollow element opening and the second hollow element opening protrude from the seal so that the openings are unsealed. In the closed state of the device, the seal seals the first hollow element opening and the second hollow element opening, being the seal biased towards the closed state by the elastic element.

### BACKGROUND

Printing systems may recirculate their printing fluids through fluid distribution systems. Some fluids, for instance inks, may comprise particles which should be in motion, either constantly or periodically, so as to preserve their properties. It is hereby disclosed recirculation devices and systems in which fluids can be recirculated within a printing system.

### BRIEF DESCRIPTION OF DRAWINGS

Features of the present disclosure are illustrated by way of example and are not limited in the following figure(s), in which like numerals indicate like elements, in which:

FIG. 1 shows a recirculation device having a fluid interconnect assembly, according to an example of the present disclosure;

FIG. 2 shows a recirculation device having a first module and a second module, according to an example of the present disclosure;

FIG. 3 shows a recirculation device having a first guiding element and a second guiding element, according to an example of the present disclosure;

FIG. 4 shows a printing system comprising an ink delivery system and a fluid bridge, according to an example of the present disclosure;

FIG. 5 shows a printing system comprising a fluid interface and a fluid bridge, according to an example of the present disclosure;

FIG. 6A shows a cross-sectional view of the fluid interface and the fluid bridge of FIG. 5 in a closed state;

FIG. 6B shows a cross-sectional view of the fluid interface and the fluid bridge of FIG. 5 in an open state.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Printing systems may comprise a series of printheads to eject a fluid on a print media. Such fluid flows from fluid supplies to the series of printheads through a series of fluid lines. The series of fluid lines may comprise additional devices to control fluid parameters such as the fluid pressure, the density of the fluid, the flow rate, amongst other possibilities.

Some additional devices, such as pumps, may use those fluid parameters to control their operations. Also, the series of fluid lines may be interconnected to each other in order to reduce the dimensions of the system, and therefore, a fluid line may be used for different purposes based on which operation is executing the printing system.

Other additional devices, such as valves, may be used to guide the fluid in the desired direction, and therefore, a specific fluid path may be created within the fluid lines based on the state of the valves. However, in some cases, the redirection of fluid in a particular fluid path direction may not be achieved merely by opening and/or closing fluid lines comprised within the series of fluid lines. Examples of path directions which may not be obtained are the fluid paths that supply fluid to the printheads. In case that no printhead is inserted, the fluid comprised inside these lines may not be recirculated.

In an example, a fluid distribution system may comprise fluid lines and additional devices in order to supply fluid from fluid supplies to a series of printheads. However, the fluid distribution system may be used for other purposes, such as recirculate the fluid through the series of lines. For the recirculation of the fluid, additional devices may create an internal fluid path in which the fluid is not supplied to the printheads.

According to an example, a printing system may comprise a printhead that distribute different types of fluid. Since fluids may behave differently depending on their properties, a fluid distribution system of the printing system may perform different actions to the fluid based on a fluid type. In an example, the fluid distribution system may supply two different types of inks: a high-pigmented fluid and a low-pigmented fluid. Whereas the low-pigmented fluid may keep its properties substantially unchanged while not being used, the high-pigmented fluid may be recirculated periodically to maintain some of its properties, e.g., their absorbance or their viscosity. In case that the high-pigmented fluid is not enough recirculated, its properties may be affected.

As used herein, the absorbance of a fluid refers to an amount of light absorbed by a solution. For high-pigmented fluids, if the fluid is not well mixed, fluid measures will not be homogeneous in the fluid distribution system, and therefore, image quality defects may be obtained during printing operations, such as plot opacity variations.

As used herein, the viscosity of a fluid refers to a measure of the resistance of a fluid to deformation. In case that the fluid may not be recirculated, its pigments may settle, thereby increasing its viscosity. Additional devices, such as pumps, may not be able to work with high-viscosity fluids.

In another example, a user may decide to replace one of the printheads of a printing system for a dummy printhead, wherein the dummy printhead can loop fluid back to the fluid distribution system of the printing system instead of ejecting it. Dummy printheads may enable the printing system to keep executing printing operations while using a lower number of printheads. Examples of dummy printheads comprise fluid bridges, recirculation devices, amongst other examples.

Disclosed herein are examples of devices and systems which may be used to recirculate a fluid within a printing system. Hence, different examples of devices and systems are described.

In some examples, a printing system comprises a fluid distribution system to supply ink to a series of printheads. The fluid distribution system may comprise a series of fluid interfaces (alternatively referred to as fluid interconnect holders) in which the series printheads are to be connected. A connection of one of the printheads to one of the fluid interfaces may extend the fluid distribution system by creating an internal fluid path. Upon the printhead is connected to the fluid interface, fluid can be supplied to the printhead. In other examples, printhead(s) may be replaced for recirculation devices which may recirculate the fluid supplied through the fluid interface(s).

According to an example, a recirculation device having a fluid interconnect assembly comprises an open state and a closed state. The fluid interconnect assembly may comprise an elastic element, a first hollow element, a second hollow element, and a seal movable along the fluid interconnect assembly. The first hollow element and the second hollow element comprise an opening, wherein the hollow elements are fluidly connected. In the open state of the device, the first hollow element opening and the second hollow element opening protrude from the seal so that the openings are unsealed. In the closed state of the device, the seal seals the first hollow element opening and the second hollow element opening, being the seal biased towards the closed state by the elastic element.

In an example, the recirculation device may further comprise a guiding element attached to the seal, wherein the guiding element is movable along a guide which is parallel to the first hollow element and the second hollow element. In some examples, the guide is an aperture of the fluid interconnect assembly.

In other examples, the openings of the first hollow element and the second hollow element are lateral apertures.

In some other examples, the recirculation device changes from the closed state to the open state if the device is connected to a printing device, for instance a fluid interface of a fluid distribution system.

According to other examples, a recirculation device, instead of a fluid interconnect assembly, comprises a first module and a second module, wherein each module having an open state and a close state. The first module may comprise a first elastic element, a first hollow element and a first seal movable along the first module and the second module may comprise a second elastic element, a second hollow element and a second seal movable along the second module. Each of the first and the second hollow elements comprises an opening, being the second hollow element fluidly connected to the first hollow element. In the open state, the openings of the first hollow element and the second hollow element protrude from the first seal and the second seal so that the openings are unsealed. In the closed state, the first seal and the second seal cover the openings, thereby blocking them. The first seal and the second seal are biased towards the closed state by the first elastic element and the second elastic element.

In an example, the recirculation device may be connected to a printing system. Upon connecting the recirculation device to the printing system, the device changes from the closed state to the open state, thus creating a fluid path between the first hollow element opening and the second hollow element opening. In some examples, the recirculation device may be connected to a fluid interface of the printing system.

In other examples, the recirculation device may further comprise a first guiding element attached to the first seal and a second guiding element attached to the second seal. The first guiding element may be movable along a first guide and the second guiding element may be movable along a second guide. The first guide may be parallel to the first hollow element and the second guide may be parallel to the second hollow element. In some other examples, the first guide is an aperture of the first module and the second guide is an aperture of the second module.

According to some examples, a printing system comprises an ink delivery system and a fluid bridge. The ink delivery system may supply fluid to a fluid interface, as previously described in the description. The fluid bridge may have a chamber assembly, wherein the chamber assembly comprises a first hollow element fluidly connected to a second hollow element, a sealing element movable along the chamber assembly, and an elastic element contacting the sealing element and the chamber assembly. The first and the second hollow element comprise an opening, wherein the sealing element is to seal the opening. The sealing element is biased towards sealing the openings by the elastic element, and upon connecting the fluid bridge to the fluid interface, the sealing element moves away so that the openings are unsealed. Once the openings are unsealed, fluid may flow between the first hollow element opening and the second hollow element opening. In some examples, the ink delivery system corresponds to the fluid distribution system previously described in the description.

In other examples, the fluid bridge of the printing system further comprises a guiding element attached to the sealing element, wherein the guiding element is movable within a guide parallel to the first hollow element and the second hollow element. The guiding element may prevent the tilting of the sealing element during a movement along the chamber assembly.

In some other examples, the ink delivery system may reduce a fluid pressure when an extraction of the fluid bridge is detected by the printing system. In an example, the extraction of the fluid bridge is determined by checking a printing system status.

According to other examples, the chamber assembly may comprise a first module and a second module, the sealing element may comprise a first sealing element and a second sealing element, and the elastic element may comprise a first portion and a second portion. The first module may comprise the first hollow element, the first sealing element, and the first portion of the elastic element. The second module may comprise the second hollow element, the second sealing element, and the second portion of the elastic element.

The first sealing element may seal the first hollow element opening and the first portion of the elastic element may contact the first module and the first sealing element.

The second sealing element may seal the second hollow element opening and the second portion of the elastic element may contact the second module and the second sealing element. Upon connecting the fluid bridge to the fluid interface, each of the first sealing element and the second sealing element moves away so that the openings are unsealed.

Examples of elastic elements may comprise, amongst others, springs, gas canisters, or any element capable of recovering size and shape after a deformation, for example, a deformation caused by the process transmitted forces.

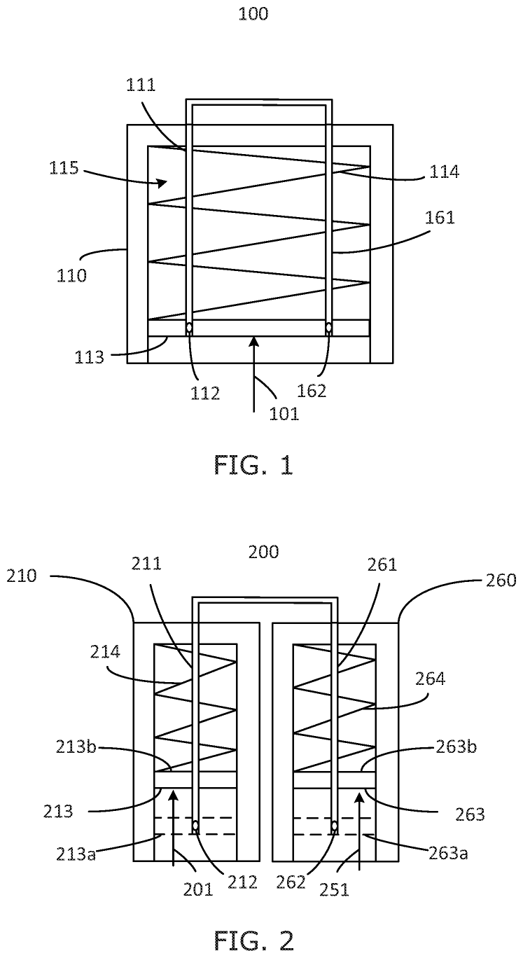

Referring now to FIG. 1, a recirculation device 100 having a fluid interconnect assembly 110 is shown. The recirculation device 100 further comprises an elastic element 114, a first hollow element 111, a second hollow element 161, and a seal 113. The first hollow element 111 comprises a first opening 112 and the second hollow element 161 comprises a second opening 162. In the example of FIG. 1, the openings are lateral apertures, however, alternative locations may be possible, such as openings on the hollow elements' tips. In an example, the first and second hollow elements are integrally formed into a single element, e.g., a U-shaped element including the first hollow element and the second hollow element.

The first hollow element 111 is fluidly connected to the second hollow element, and thus, a fluid path may be created between both openings. The seal 113 is movable along a cavity 115 of the fluid interconnect assembly 110, wherein the seal 113 is to seal the first hollow element opening 112 and the second hollow element opening 162 by covering the openings.

The recirculation device 110 may comprise an open state and a closed state, wherein the seal is biased towards the closed state by the elastic element 114. In the closed state, the seal 113 covers the openings so that the first hollow element opening 112 and the second hollow element opening 162 are sealed. By sealing the openings, the fluid inside the first hollow element 111 and the second hollow element 161 remains inside, thereby preventing its spilling. In the open state, the first hollow element opening 112 and the second hollow element opening 162 protrude from the seal 113, and thus, the openings are unsealed thereby allowing fluid to flow between the openings of each of the hollow elements.

As shown in FIG. 1, a transition between a closed state and an open state is caused when the seal 113 performs a movement 101. The movement 101 of the seal 113 causes the openings to protrude from the seal 113, thus creating a fluid path between the first hollow element opening 112 and the second hollow element opening 162. In an example, the movement 101 may be caused by a connection of the recirculation device 100 to a printing device, e.g. a printing system. The printing system may comprise a fluid interface in which the recirculation device 100 can be connected so that the recirculation device 100 creates a new fluid path for the printing system. In an example, the new fluid path corresponds to an inner fluid path which enables to keep the fluid in motion.

In some examples, the first hollow element 111 and the second hollow element 161 are connected through a common chamber, wherein the common chamber is a shared volume between the first hollow element 111 and the second hollow element 161. The volume of the common chamber may aid in reducing the pressure of the fluid comprised between the first hollow element 111 and the second hollow element 161 during the closed state of the recirculation device 100. Common chambers having large inner volumes may be susceptible to perform more fluid spill compared with common chambers having small inner volumes, because of the pressure of the fluid comprised inside of the fluid path defined between the two openings. However, the dimensions of the common chamber should be enough so as to enable the pigments of the fluid to pass through the chamber without clogging the fluid path between the first hollow element 111 and the second hollow element 161.

In some other examples, the first hollow element 111 and second hollow element 161 may be integrally formed into a single element, e.g., a U-shaped element including the first hollow element 111 and the second hollow element 161.

Referring now to FIG. 2, a recirculation device 200 having a first module 210 and a second module 260 is shown. The first module 210 comprises a first hollow element 211 having a first hollow element opening 212, a first seal 213, and a first elastic element 214. In the same way, the second module 260 comprises a second hollow element 261 having a second hollow element opening 262, a second seal 263, and a second elastic element 264.

As previously explained in reference to other examples, the recirculation device 200 comprises an open state in which the openings protrude from the first seal 213 and the second seal 263, and a closed state in which the first seal 213 and the second seal 263 block the openings. The first seal 213 and the second seal 263 are biased towards the closed state by the first elastic element 214 and the second elastic element 264. The first hollow element 211 is fluidly connected to the second hollow element 261, and during an open state of the recirculation device 200, a fluid path is enabled between the first hollow element opening 212 and the second hollow element opening 262.

As shown in FIG. 2, each of the first seal 213 and the second seal 263 is movable along a cavity of the first module 210 and a cavity of the second module 260, respectively. A first movement 201 illustrates how the first seal 213 moves from a closed position 213a to an open position 213b. A second movement 251 illustrates how the second seal 263 moves from a closed position 263a to an open position 263b.

If the seals 213, 263 are in their closed position 213a, 263a, each of the first hollow element opening 212 and the second hollow element opening 262 are covered by the first seal 213 and the second seal 263 so that the openings are sealed. The sealing of the openings prevents the spill of the fluid that may be inside the first hollow element 211 and the second hollow element 261.

The open position 213b of the first seal 213 and the open position 263b of the second seal 263 correspond to the open state of the recirculation device 200. In the open state, each of the first hollow element opening 212 and the second hollow element opening 262 protrude from the first seal 213 and the second seal 263 so that the openings are unsealed.

In an example, the first hollow element 211 and the second hollow element 261 are needles, wherein the needles may be made of a material which can stand corrosion. The needles may have their openings at a lateral surface of their bodies, and thus, the seals can prevent the spill of the fluid which may be comprised along the fluid path enabled between the first hollow element opening 212 and the second hollow element opening 262.

In other examples, the recirculation device 200 may further comprise guiding elements to ensure that each of the first seal and the second seal is aligned with their corresponding hollow element, thereby preventing the tilting of the seals. In an example, the recirculation device 200 further comprise a first guiding element attached to the first seal 213 and a second guiding element attached to the second seal 263. The first guiding element is movable along a first guide and the second guiding element is movable along the second guide, wherein the first guide is parallel to the first hollow element 211 and the second guide is parallel to the second hollow element 261.

In some other examples, the first module 210 and the second module 260 may have different relative position with each other. Although in FIG. 2 the first hollow element 211 is parallel to the second hollow element 261, other alternatives may be possible, such as the second module 260 being perpendicular to the first module 210 so that the recirculation device 200 is L-shaped.

In some other examples, the first hollow element 211 and the second hollow element 261 are connected through a common chamber, wherein the common chamber is a shared volume between the first hollow element 211 and the second hollow element 261, as previously explained. In other examples, the first hollow element 211 and second hollow element 261 may be integrally formed into a single element, e.g., a U-shaped element including the first hollow element 211 and the second hollow element 261.

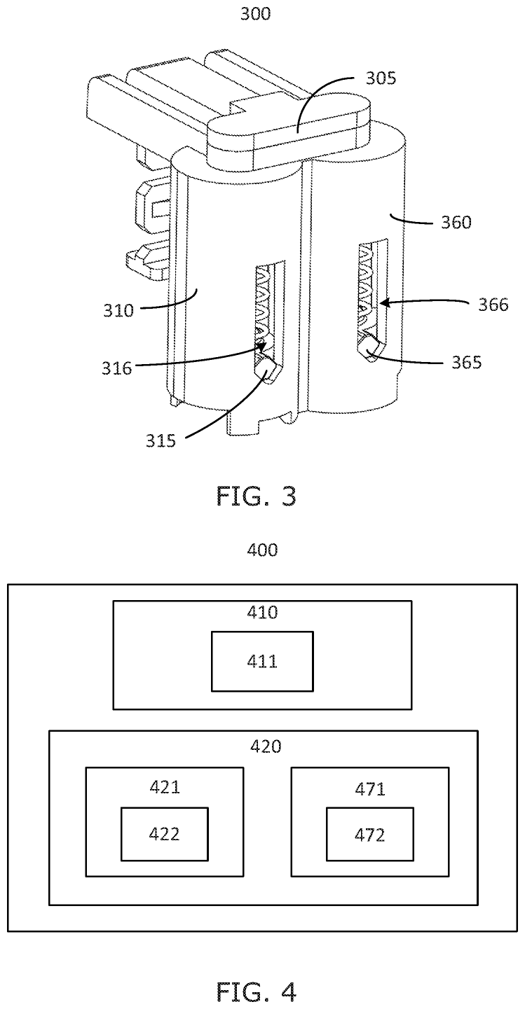

Referring now to FIG. 3, a recirculation device 300 having a first guiding element 315 and a second guiding element 365 is shown. The recirculation device 300 further comprises a first module 310 and a second module 360, wherein each of the first module 310 and the second module 360 may correspond to the first module and the second module previously explained in reference to FIG. 2.

The recirculation device 300 further comprises a common chamber 305, wherein the common chamber 305 fluidly connects the hollow elements (not shown in FIG. 3). In other examples, the common chamber may be replaced for other alternatives, such an additional hollow element connecting the first hollow element to the second hollow element.

The first module 310 comprises the first guiding element 315 and the second module 360 comprises the second guiding element 365, wherein the guiding elements are movable within guides that are parallel to their respective hollow element. In the example of FIG. 2, a first guide 316 and a second guide 366 are lateral apertures of each of the first module 310 and the second module 360. However, in other examples the guides may be disposed at other locations, for instance on inner surfaces of the modules (or module).

In some other examples, the first module 310 and the second module 360 may be replaced for a single chamber assembly. The chamber assembly may comprise a single elastic element, a single sealing element while defining a closed state and an open state for the recirculation device, as previously explained in reference to FIG. 1.

According to an example, a printing system may comprise an ink delivery system to supply fluid to a fluid bridge through a fluid interface, wherein the fluid bridge corresponds to the recirculation device previously explained in other examples. The fluid bridge comprises a chamber assembly, wherein the chamber assembly comprises a first hollow element fluidly connected to a second hollow element, a sealing element, and an elastic element. Each of the first hollow element and the second element comprise an opening, and the sealing element is biased by the elastic element towards a position in which the openings are sealed. Upon connecting the fluid bridge to the fluid interface, the sealing element moves away so that the openings of the hollow elements are unsealed. Once the openings are unsealed, a new fluid path may be enabled within the ink delivery system so that fluid can be flowed between the first hollow element opening and the second hollow element opening.

In other examples, the chamber assembly comprises a first module and a second module, the sealing element comprises a first sealing element and a second sealing element, and the elastic element comprises a first portion and a second portion. The first module may comprise the first hollow element, the first sealing element and the first portion of the elastic element. The second module may comprise the second hollow element, the second sealing element and the second portion of the elastic element.

As previously noted, each of the first sealing element and the second sealing element is biased towards a closed state by each of the first portion of elastic element and second portion of elastic element. In the closed state, the openings of the first hollow element and the second hollow element are sealed. Upon connecting the fluid bridge to the fluid interface, each of the first sealing element and the second sealing element moves away so that the openings of the hollow elements are unsealed. Once the openings are unsealed, a new fluid path may be enabled within the ink delivery system so that fluid can be flowed between the first hollow element opening and the second hollow element opening.

Referring now to FIG. 4, a printing system 400 comprising an ink delivery system 410 and a fluid bridge 420 is shown. The ink delivery system 410 is to supply fluid to a fluid interface 411, wherein the ink delivery system 410 may correspond to the fluid distribution systems previously described in the description. The fluid bridge 420 is connectable to the fluid interface 411 of the ink delivery system 410 so that fluid can be supplied to the fluid bridge 420.

The fluid bridge 420 comprises a first hollow element 421 and a second hollow element 471, wherein the first hollow element 421 comprises a first opening 422 and the second hollow element comprises a second opening 472. The fluid bridge 420 may comprise a chamber assembly for the hollow elements, wherein the assembly may be a single chamber or multiple modules. When having a fluid bridge 420 with a single chamber, the fluid bridge 420 further comprises an elastic element and a sealing element in addition to the first hollow element 421 and the second hollow element 471. When having a fluid bridge 420 with a first module and a second module, the fluid bridge 420 may further comprise a first sealing element and a second sealing element, and a first portion of elastic element and a second portion of elastic element, as previously explained in the description.

The fluid bridge 420 comprises an open state in which a new fluid path is enabled and a closed state in which the new fluid path is blocked. Upon connecting the fluid bridge 420 to the fluid interface 411, the fluid bridge 420 changes its state from closed state to open state. The connection may cause the first opening 422 of the first hollow element 421 and the second opening 472 of the second hollow element 471 to protrude of the sealing element (or sealing elements when having two modules). Once the sealing element(s) move away from the openings, the new fluid path is enabled between the first opening 422 and the second opening 472. The new fluid path may enable to flow fluid of the ink delivery system 410 back to the ink delivery system 410.

However, a user may want to replace the fluid bridge 420 for a printhead in order to execute printing operations. Before extracting the fluid bridge 420 from the printing system 400, the user may indicate to the printing system 400 that an extraction operation is to be executed.

In an example, the printing system further comprises a processor comprising instructions to perform a method comprising a series of actions to extract a fluid bridge 420 from the printing system 400. In case the printing system 400 detects an extraction of the fluid bridge 420, the printing system 400 may reduce a fluid pressure of the ink delivery system 410. In some examples, the extraction of the fluid bridge 420 is determined by checking a printing system status, wherein the printing system status indicates the status of the actions that the printing system 400 is executing. Once the fluid bridge 420 is extracted from the fluid interconnect interface 411, the fluid bridge changes from the open state to the closed state, and thus, the first opening 422 and the second opening 472 are sealed. Due to the sealing of the first opening 422 and the second opening 472, the new fluid path which was enabled during the open state to flow fluid back to the ink delivery system 410 is blocked.

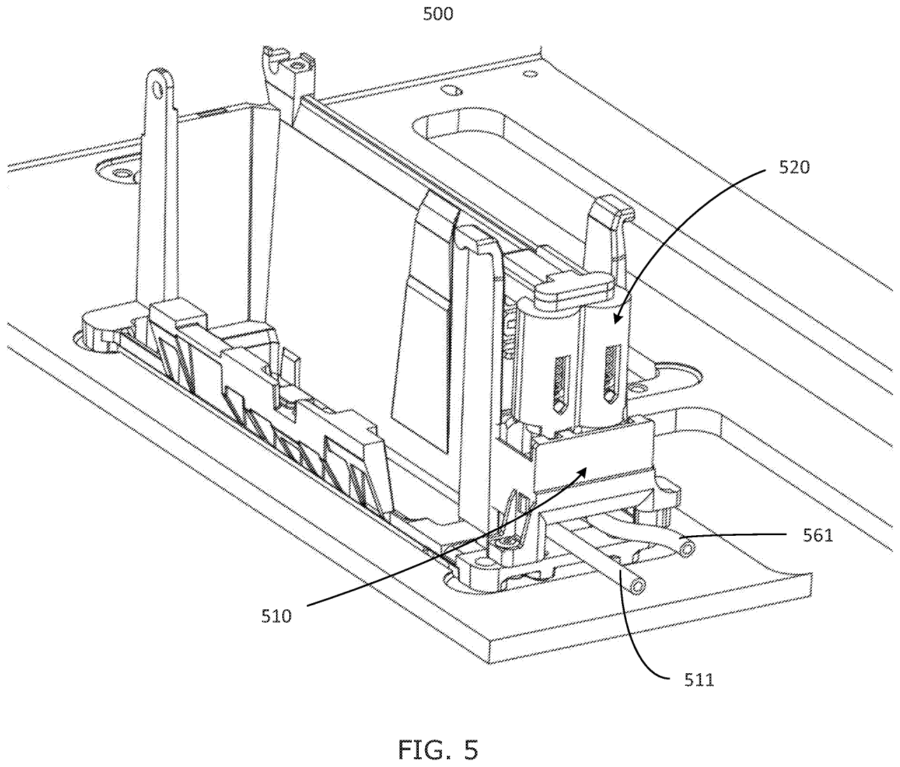

Referring now to FIG. 5, a printing system 500 is shown. The printing system 500 comprises a fluid interface 510 and a fluid bridge 520. The fluid bridge 520 may correspond to the recirculation device 300 previously explained in FIG. 3. However, other examples of recirculation devices or fluid bridges may be possible, such as recirculation devices or fluid bridges having a chamber assembly, recirculation devices or fluid bridge without guiding elements, amongst others.

The fluid interface 510 is fluidly connected to the ink delivery system (not shown in FIG. 5) of the printing system 500 by a first line 511 and a second line 561. The ink delivery system may supply fluid to the fluid interface 510 through the first line 511 and/or the second line 561.

In the example of FIG. 5, the fluid bridge520 is not connected to the fluid interconnect interface 510, and therefore, it is in a closed state. However, if the fluid bridge 520 is pressed downwards, the sealing elements of the fluid bridge 520 may move upwards relative to the modules. As a result of the movement, the fluid bridge 520 changes from the closed state to an open state in which a new fluid path is enabled between a first hollow element opening and a second hollow element opening. In case that the ink delivery system may flow fluid to the fluid interface 510 through the first line 511, the fluid may flow through the fluid bridge 520 to the second line 561. In the same way, if the ink delivery system flows fluid to the fluid interface 510 through the second line 561, the fluid flows through the fluid bridge 520 to the first line 511.

According to some examples, the ink delivery system of the printing system 500 may reduce a fluid pressure when an extraction of the fluid bridge 520 is detected by the printing system 500. The fluid pressure may correspond to a pressure of the fluid which is to be flowed through the new fluid path enabled by the fluid bridge 520 during the open state. In some other examples, the extraction of the fluid bridge 520 is determined by checking a printing system status.

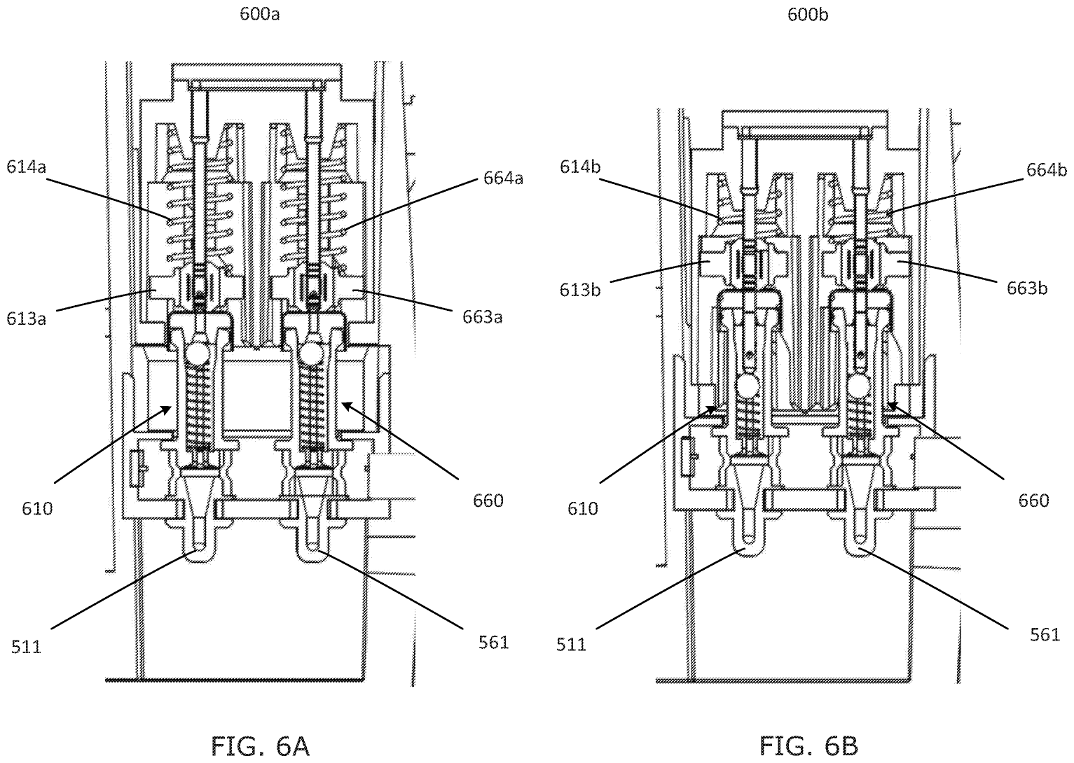

Referring now to FIG. 6A, a cross-sectional view of the fluid interface 510 and the fluid bridge 520 of FIG. 5 is shown in a closed state 600a. As previously explained in FIG. 5, the first line 511 and the second line 561 connect the ink delivery system of the printing system 500 to the fluid interface 510.

During the closed state 600a of the fluid bridge 520, the ink delivery system cannot flow fluid from a first fluid chamber 610 of the fluid interface 510 to a second fluid chamber 660 of the fluid interface 510. A first sealing element 613a and a second sealing element 663a are biased by a first elastic element 614a and a second elastic element 664a towards to seal the openings of the hollow elements of the recirculation device 520, and therefore, a fluid path between the first hollow element opening and the second hollow element opening is not enabled. During the closed state 600a, the first elastic element 614a and the second elastic element 664a are in a relaxed state. When using springs as elastic elements, the relaxed state may be referred to as an expanded state of the spring.

Referring now to FIG. 6B, a cross-sectional view of the fluid interconnect interface 510 and the fluid bridge 520 of FIG. 5 is shown in an open state 600b.

During the open state 600b of the fluid bridge 520, a first sealing element 613b and a second sealing element 663b are moved away from each of the first hollow element opening and the second hollow element opening, and therefore, the openings protrude from the sealing elements. As a result, a fluid path is enabled between the first hollow element opening and the second hollow element opening. In case the ink delivery system may flow fluid to either the first line 511 or the second line 561, the fluid may flow from the first fluid chamber 610 (or the second fluid chamber 660) to the second fluid chamber 660 (or the first fluid chamber 610 when supplying fluid from the second supply chamber 660). During the open state 600b, a first elastic element 614b and a second elastic element 664b are in a deformed state. When using springs as elastic elements, the deformed state may be referred to as a contracted state of the spring.

In other examples, the fluid interconnect interface 510 of the FIGS. 6A and 6B may use a different system to engage with the fluid bridge 520. In some other examples, the fluid bridge 520 may comprise a single chamber assembly having a single sealing element, as previously explained in the description. In other examples, the first hollow element and the second hollow element may be fluidly connected through an additional hollow element, as previously explained.

In some examples, the fluid bridge 520 may prevent the spill of fluid comprised inside the first hollow element opening and the second hollow element opening. In case that the fluid bridge 520 is disengaged from the fluid interface 510, the fluid bridge 520 changes from the open state 600b to the closed state 600a. As a result, the elastic elements recover their original size, thereby moving the sealing elements back to a position in which the first hollow element opening and the second hollow element opening are sealed. Therefore, if fluid is supplied to either the first fluid chamber 610 by the first line 511 or the second fluid chamber 660 by the second line 561, the fluid cannot be flowed back to the ink delivery system.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A recirculation device having a fluid interconnect assembly comprising:
an elastic element;
a first hollow element and a second hollow element, wherein the first and the second hollow elements comprise an opening, being the second hollow element fluidly connected to the first hollow element; and
a seal movable along the fluid interconnect assembly,
wherein the device comprises an open state in which the first hollow element opening, and the second hollow element opening protrude from the seal so that the openings are unsealed; and a closed state in which the seal seals the first hollow element opening and the second hollow element opening, being the seal biased towards the closed state by the elastic element.

2. A recirculation device as claimed in claim 1, wherein the first hollow element and the second hollow element are fluidly connected through a common chamber.

3. A recirculation device as claimed in claim 1 further comprising a guiding element attached to the seal, wherein the guiding element is movable along a guide, wherein the guide is parallel to the first hollow element and the second hollow element.

4. A recirculation device as claimed in claim 3, wherein the guide is an aperture of the fluid interconnect assembly.

5. A recirculation device as claimed in claim 1, wherein the first hollow element opening is a lateral aperture of the first hollow element and the second hollow element opening is a lateral aperture of the second hollow element.

6. A recirculation device as claimed in claim 1, wherein the device changes from the closed state to the open state if the device is connected to a printing device.

7. A recirculation device comprising:
a first module comprising:
a first elastic element;
a first hollow element; and,
a first seal movable along the first module; and,
a second module comprising:
a second elastic element;
a second hollow element; and,
a second seal movable along the second module,
wherein each of the first and the second hollow elements comprise openings, being the second hollow element fluidly connected to the first hollow element,
the device comprising:
an open state in which the openings protrude from the first seal and the second seal so that the openings are unsealed; and, a closed state in which the first seal and the second seal block the openings,
wherein the first seal and the second seal are biased towards the closed state by the first elastic element and the second elastic element.

8. A recirculation device as claimed in claim 7, wherein the recirculation device further comprises:
a first guiding element attached to the first seal; and,
a second guiding element attached to the second seal,
wherein the first guiding element is movable along a first guide and the second guiding element is movable a second guide,
wherein the first guide is parallel to the first hollow element and the second guide is parallel to the second hollow element.

9. A recirculation device as claimed in claim 8, wherein the first guide is an aperture of the first module and the second guide is an aperture of the second module.

10. A recirculation device as claimed in claim 7, wherein if the device is connected to a printing device, the device changes from the closed state to the open state.

11. A printing system comprising:
an ink delivery system to supply fluid to a fluid interface; and,
a fluid bridge having a chamber assembly, wherein the chamber assembly comprises:
a first hollow element fluidly connected to a second hollow element, wherein the first and the second hollow elements comprise an opening, and,
a sealing element to seal the openings; and,
an elastic element contacting the sealing element and the chamber assembly,
wherein the sealing element is biased towards sealing the openings by the elastic element,
wherein upon connecting the fluid bridge to the fluid interface, the sealing element moves away so that the openings are unsealed, wherein fluid flows between the first hollow element opening and the second hollow element opening.

12. A system as claimed in claim 11, wherein the fluid bridge further comprises a guiding element attached to the sealing element, wherein the guiding element is movable within a guide parallel to the first hollow element and the second hollow element.

13. A system as claimed in claim 11, wherein the chamber assembly comprises a first module and a second module, the sealing element comprises a first sealing element and a second sealing element, and the elastic element comprises a first portion and a second portion,
the first module comprising:
the first hollow element;
the first sealing element to seal the first hollow element opening; and,
the first portion of the elastic element contacting the first module and the first sealing element; and,
the second module comprising:
the second hollow element;
the second sealing element to seal the second hollow element opening; and,
the second portion of the elastic element contacting the second module and the second sealing element,
wherein upon connecting the fluid bridge to the fluid interface, each of the first sealing element and the second sealing element moves away so that the openings are unsealed.

14. A system as claimed in claim 11, wherein the ink delivery system reduces a fluid pressure when an extraction of the fluid bridge is detected by the printing system.

15. A system as claimed in claim 14, wherein the extraction of the fluid bridge is determined by checking a printing system status.
